(19) United States
(12) Patent Application Publication
(10) Pub. No.: US 2024/0359521 A1
(43) Pub. Date: Oct. 31, 2024

(54) VEHICLE VIBRATION DAMPING SYSTEM

(71) Applicant: TOYOTA JIDOSHA KABUSHIKI KAISHA, Toyota-shi Aichi-ken (JP)

(72) Inventor: Yanqing Liu, Susono-shi Shizuoka-ken (JP)

(73) Assignee: TOYOTA JIDOSHA KABUSHIKI KAISHA, Toyota-shi Aichi-ken (JP)

(21) Appl. No.: 18/631,805

(22) Filed: Apr. 10, 2024

(30) Foreign Application Priority Data
Apr. 26, 2023 (JP) 2023-072446

(51) Int. Cl. B60G 17/018

(52) U.S. Cl. CPC B60G 17/018

(57) ABSTRACT

A vehicle vibration damping system includes a suspension; an actuator; and a control device configured to calculate a damping force to be applied to the sprung structure based on a theory of skyhook control, and control the actuator. The control device calculates the damping force based on a correction control parameter obtained by multiplying a control parameter of a denominator of a transfer function of the sprung structure with respect to a road surface displacement of a vibration model having a virtual skyhook damper by a function for canceling a coefficient of a control parameter term. The control parameter is a product of an attenuation coefficient of the skyhook damper and a Laplace operator. The function is a function having a coefficient of the control parameter term of the transfer function as a denominator, and includes at least a quadratic term of the Laplace operator in a numerator.

### CROSS-REFERENCE TO RELATED APPLICATIONS

This application claims priority to Japanese Patent Application No. 2023-072446 filed Apr. 26, 2023, the entire contents of which are herein incorporated by reference.

### FIELD

The present disclosure relates to a vehicle vibration damping system.

### BACKGROUND

JP2019-135120A discloses a conventional vehicle vibration damping control device configured to calculate a target damping force to be applied to a sprung structure (vehicle body) on the basis of a theory of skyhook control, and control an actuator applying a vertical control force between an unsprung structure (wheel) and the sprung structure on the basis of the target damping force.

### SUMMARY

The above-described conventional vehicle vibration damping control device has room for improvement with respect to a vibration damping performance in the vicinity of an unsprung resonance frequency where a fixed point is present.

The present disclosure has been made focusing on such problems, and an object thereof is to improve the vibration damping performance in the vicinity of the unsprung resonance frequency where the fixed point is present.

In order to solve the above problem, a vehicle vibration damping system according to an aspect of the present disclosure comprises: a suspension configured to connect an unsprung structure including a tire and an sprung structure including a vehicle body; an actuator configured to apply a vertical control force between the unsprung structure and the sprung structure; and a control device configured to calculate a damping force to be applied to the sprung structure on the basis of a theory of skyhook control, and control the actuator on the basis of the damping force.

The control device is configured to calculate the damping force based on a correction control parameter obtained by multiplying a control parameter of a denominator of a transfer function of the sprung structure with respect to a road surface displacement of a vibration model having a virtual skyhook damper by a function for canceling a coefficient of a control parameter term. The control parameter is a product of an attenuation coefficient of the skyhook damper and a Laplace operator. The function is a function having a coefficient of the control parameter term of the transfer function as a denominator, and includes at least a quadratic term of the Laplace operator in a numerator.

According to this aspect of the present disclosure, the vibration damping performance in the vicinity of the unsprung resonance frequency in which the fixed point is present can be improved.

### BRIEF DESCRIPTION OF DRAWINGS

FIG. 1 is a schematic view of a vehicle vibration damping system according to an embodiment of the present disclosure.

FIG. 2 is a view showing a two-degree of freedom vibration model provided with a virtual skyhook damper.

FIG. 3A is a view showing a transfer characteristic of sprung displacement with respect to road surface displacement when a respective function T_{filt0} is used as a correcting function.

FIG. 3B is a view showing a transfer characteristic of sprung displacement with respect to road surface displacement when a respective function T_{filt1} is used as a correcting function.

FIG. 3C is a view showing a transfer characteristic of sprung displacement with respect to road surface displacement when a respective function T_{filt2} is used as a correcting function.

FIG. 4A is a view showing a change in a transfer characteristic due to a difference in responsiveness of an actuator when a function T_{filt1}, T_{filt2} are used as a correcting function when the responsiveness of the actuator is low.

FIG. 4B is a view showing a change in a transfer characteristic due to a difference in responsiveness of an actuator when a function T_{filt1}, T_{filt2} are used as a correcting function when the responsiveness of the actuator is high.

FIG. 4C is another view showing a change in a transfer characteristic due to a difference in responsiveness of an actuator when a function T_{filt1}, T_{filt2} are used as a correcting function when the responsiveness of the actuator is low.

FIG. 5A is a view comparing a transfer characteristic when an unsprung mass M₁ is set to the actual value and a transfer characteristic when the unsprung mass M₁ is set to be smaller than the actual value.

FIG. 5B is a view comparing a transfer characteristic when an unsprung mass M₁ is set to the actual value and a transfer characteristic when the unsprung mass M₁ is set to be larger than the actual value.

FIG. 6A is a view comparing a transfer characteristic when a spring constant K₁ of a tire is set to the actual value and a transfer characteristic when the spring constant K₁ of the tire is set to be smaller than the actual value.

FIG. 6B is a view comparing a transfer characteristic when a spring constant K₁ of a tire is set to the actual value and a transfer characteristic when the spring constant K₁ of the tire is set to be larger than the actual value.

### DESCRIPTION OF EMBODIMENTS

Below, referring to the drawings, an embodiment of the present disclosure will be explained in detail. Note that, in the following explanation, similar component elements will be assigned the same reference notations.

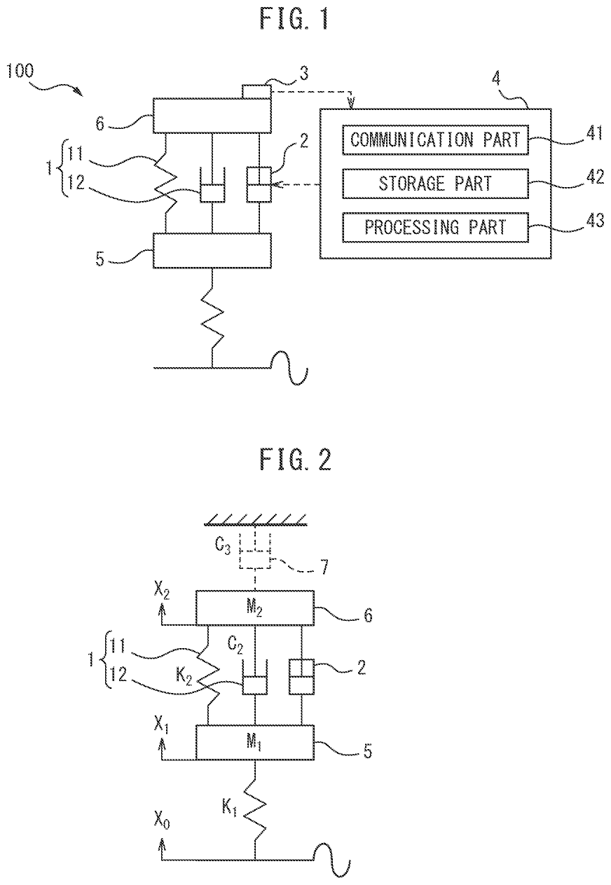

FIG. 1 is a schematic view of a vehicle vibration damping system 100 according to an embodiment of the present disclosure.

The vehicle vibration damping system 100 is provided with a suspension 1, an actuator 2, sensors 3, and a control device 4.

The suspension 1 is provided with a suspension spring 11 and a shock absorber 12, and connects an unsprung structure 5 including a tire and a sprung structure 6 including a vehicle body.

The actuator 2 controls the stroke amount of the suspension 1 by applying a vertical control force between the unsprung structure 5 and the sprung structure 6. The actuator 2 according to the present embodiment is, for example, an electric or hydraulic actuator 2, and generates a damping force calculated based on a theory of skyhook control. The shock absorber 12 may function as the actuator 2 by using the shock absorber 12 as a damping force variable type.

The sensors 3 acquire various types of data necessary for controlling the actuator 2. The sensors 3 include, for example, an acceleration sensor that detects the vertical acceleration of the vehicle body.

The control device 4 is an ECU (electronic control unit) provided with a communication part 41, storage part 42, and processing part 43.

The communication part 41 is provided with an interface circuit for connecting the control device 5 to the actuator 2 and the sensors 3. The communication part 41 supplies data received from the sensors 3 to the processing part 43.

The storage part 42 has an HDD (hard disk drive) or SSD (solid state drive), semiconductor memory, or other storage medium and stores various computer programs used for processing at the processing part 43.

The processing part 43 has one or more CPUs (central processing units) and their peripheral circuits. The processing part 43 runs various computer programs stored in the storage part 52 and, for example, is a processor. The processing unit 43, and thus the control device 4, uses various kinds of data received from the sensors 3, calculates the damping force to be applied to the sprung structure 6 based on the theory of skyhook control, and controls the actuator 2 based on the calculated damping force.

FIG. 2 is a view showing a two-degrees of freedom vibration model of a single wheel provided with a virtual skyhook damper 7.

In FIG. 2, X₀ is road surface displacement, X₁ is unsprung displacement, X₂ is the sprung displacement, M₁ is unsprung mass, M₂ is sprung mass, K₁ is a spring constant of the tire, K₂ is a spring constant of the suspension spring 11, C₂ is a damping coefficient of the shock absorber 12, and C₃ is a damping coefficient of the skyhook damper 7. The equation of motion of the two-degrees of freedom vibration model can be expressed by the following equations (1) and (2).

$$\begin{matrix}[ Mathematical 1 ] & \\ {M}_{1} {\ddot{X}}_{1} = - {K}_{2} ( {X}_{1} - {X}_{2} ) - {C}_{2} ( {\dot{X}}_{1} - {\dot{X}}_{2} ) + {C}_{3} {\dot{X}}_{2} + {K}_{1} ( {X}_{0} - {X}_{1} ) & ( 1 )\end{matrix}$$

$${M}_{2} {\ddot{X}}_{2} = {K}_{2} ( {X}_{1} - {X}_{2} ) + {C}_{2} ( {\dot{X}}_{1} - {\dot{X}}_{2} ) - {C}_{3} {\dot{X}}_{2} \qquad ( 2 )$$

Equations (1) and (2) can be expressed as in equations (3) and (4) below by Laplace transforming and putting C3·s=T_{sky0}. Note that “s” is a Laplace operator.

$$\begin{matrix}[ Mathematical 2 ] & \\ {M}_{1} {s}^{2} {X}_{1} = - {K}_{2} ( {X}_{1} - {X}_{2} ) - {C}_{2} s ( {X}_{1} - {X}_{2} ) + {T}_{sky 0} {X}_{2} + {K}_{1} ( {X}_{0} - {X}_{1} ) & ( 3 )\end{matrix}$$

$${M}_{2} {s}^{2} {X}_{2} = {K}_{2} ( {X}_{1} - {X}_{2} ) - {C}_{2} s ( {X}_{1} - {X}_{2} ) + {T}_{sky 0} {X}_{2} \qquad ( 4 )$$

A transfer function G(s) of the sprung displacement with respect to the road surface displacement can be expressed from equations (3) and (4) as in equation (5).

$$\begin{matrix}[ Mathematical 3 ] & \\ G ( s ) = \frac{{X}_{2}}{{X}_{0}} = \frac{{K}_{1} ( {K}_{2} + {C}_{2} s )}{\begin{matrix}( {M}_{2} {s}^{2} + {K}_{2} + {C}_{2} s + {T}_{sky 0} ) ( {M}_{1} {s}^{2} + {K}_{1} + {K}_{2} + {C}_{2} s ) - \\ ( {K}_{2} + {C}_{2} s ) ( {K}_{2} + {C}_{2} s + {T}_{sky 0} )\end{matrix}} & ( 5 )\end{matrix}$$

When equation (5) is modified to summarize T_{sky0} terms of the denominator, equation (6) below is obtained.

$$\begin{matrix}[ Mathematical 4 ] & \\ G ( s ) = \frac{{K}_{1} ( {K}_{2} + {C}_{2} s )}{\begin{matrix}( {M}_{2} {s}^{2} + {K}_{2} + {C}_{2} s ) ( {M}_{1} {s}^{2} + {K}_{1} + {K}_{2} + {C}_{2} s ) - \\ {( {K}_{2} + {C}_{2} s )}^{2} + {T}_{sky 0} ( {M}_{1} {s}^{2} + {K}_{1} )\end{matrix}} & ( 6 )\end{matrix}$$

When s=iω is set in equation (5) or equation (6), the transfer function G(s) becomes as shown in equation (7) below when M₁s²+K₁=0, that is, when the unsprung resonant frequency f₀=ω/2π=√(K1/M1)/2π. That is, the transfer function G(s) becomes constant regardless of the control parameter T_{sky0}. That is, the frequency f₀ becomes the fixed point frequency, and when frequency is in the frequency f₀, even if control force F (=T_{sky0}·X₂) is generated by the actuator 2, the transfer function G(s) cannot be affected. The frequency f₀ is a frequency around 10 [Hz] in the present embodiment.

$$\begin{matrix}[ Mathematical 5 ] & \\ G ( s ) = \frac{{X}_{2}}{{X}_{0}} = \frac{{K}_{1}}{{M}_{2} {s}^{2}} = - \frac{{M}_{1}}{{M}_{2}} & ( 7 )\end{matrix}$$

Therefore, in the present embodiment, control force F (=T_{sky}·X₂) of the actuator 2 is calculated using a correction control parameter T_{sky} obtained by multiplying the control parameter T_{sky0} by correction function T_{filt} for canceling the (M₁s²+K₁) of the third term (control parameter term) of the denominator of equation (6) so that the transfer function G(s) can be influenced even at the fixed point frequency.

The correction control parameter T_{sky} can be expressed as in the following equation (8), where the transfer function G(s) is as in the following equation (9).

$$\begin{matrix}[ Mathematical 6 ] & \\ {T}_{sky} = {T}_{sky 0} {T}_{filt} & ( 8 )\end{matrix}$$

$$G ( s ) = \frac{{K}_{1} ( {K}_{2} + {C}_{2} s )}{\begin{matrix}( {M}_{2} {s}^{2} + {K}_{2} + {C}_{2} s ) ( {M}_{1} {s}^{2} + {K}_{1} + {K}_{2} + {C}_{2} s ) - \\ {( {K}_{2} + {C}_{2} s )}^{2} + {T}_{sky} ( {M}_{1} {s}^{2} + {K}_{1} )\end{matrix}} \qquad ( 9 )$$

As the correction function T_{filt}, for example, the respective function T_{filt0}, T_{filt1}, T_{filt2} shown in equation (10) to equation (12) can be considered, but as a result of intensive studies by the inventors, it has been found that the damping performance of the high frequency band in the vicinity of the frequency f₀ can be improved by using the function T_{filt1} shown in equation (11) or the function T_{filt2} shown in equation (12). A coefficient Mₙ of the second-order term of the Laplacian operator and a coefficient Cₙ of the first-order term of the Laplacian operator of the numerator of equations (11) and (12) are constants set in advance by experimentation and the like, respectively.

$$\begin{matrix}[ Mathematical 7 ] & \\ {T}_{filt 0} = \frac{{K}_{1}}{{M}_{1} {s}^{2} + {K}_{1}} & ( 10 )\end{matrix}$$

$${T}_{filt 1} = \frac{{K}_{1} + {M}_{n} {s}^{2}}{{M}_{1} {s}^{2} + {K}_{1}} \qquad ( 11 )$$

$${T}_{filt 2} = \frac{{K}_{1} + {C}_{n} s + {M}_{n} {s}^{2}}{{M}_{1} {s}^{2} + {K}_{1}} \qquad ( 12 )$$

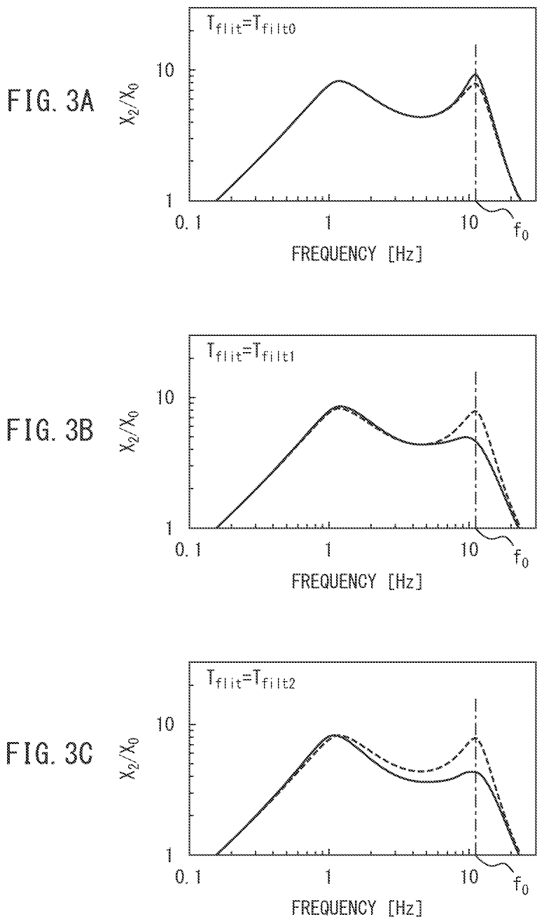

FIGS. 3A-3C are views showing transfer characteristics of the sprung displacement X₂ with respect to the road surface displacement X₀ when the respective function T_{filt0}, T_{filt1}, T_{filt2} are used as the correction functions. In FIGS. 3A-3C, for comparison, the transfer characteristic when the correction function is not used, that is, the transfer characteristics of Equation (6), are indicated by broken lines.

As shown in FIGS. 3A-3C, it can be seen that the transfer characteristic in the frequency f₀ does not become a constant value by using the correction function, and the transfer characteristic is changed by the control force F of the actuator 2 in the fixed point frequency band (the frequency band near 10 [Hz] in the present embodiment) near the frequency f₀.

However, as shown in FIG. 3A, when the function T_{filt0} is used as the correction function, the damping performance of the fixed point frequency band is conversely deteriorated in the frequency band up to approximately 30 [Hz] at which the damping effect can be obtained by the vehicle damping system 100, and the damping performance of the frequency band other than the fixed point frequency band is not changed.

On the other hand, as shown in FIG. 3B, when using the function T_{filt1} having a second-order term of the Laplace operator as the correction function, it can be seen that to improve the damping performance of the high-frequency band including the fixed point frequency band.

Then, as shown in FIG. 3C, when the function T_{filt2} further having a first-order term of the Laplace operator is used as the correction function, it can be seen that the damping performance of the medium frequency band (the frequency band in the vicinity of 1 to 10 [Hz] in the present embodiment) can be improved in addition to the high frequency band including the fixed point frequency band.

Therefore, in the present embodiment, the function T_{filt1} or the function T_{filt2} is used as the correction function. Due to this, when the function T_{filt1} is used as the correction function, the damping performance of the high frequency band including the fixed point frequency band can be improved. When the function T_{filt2} is used as the correction function, the damping performance of the medium frequency band in addition to the high frequency band including the fixed point frequency band can also be improved.

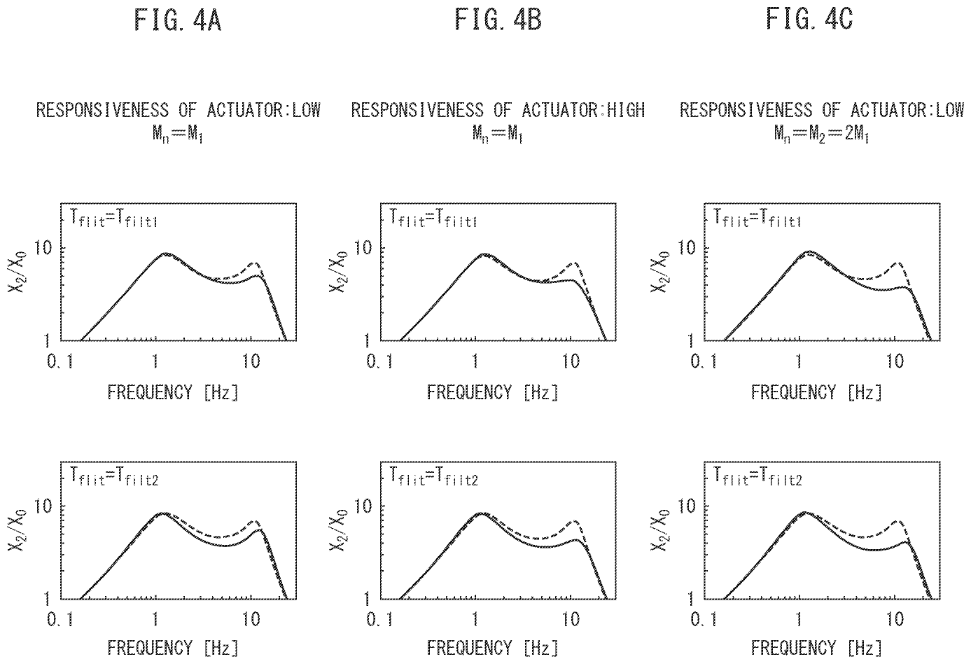

Next, the change in the transfer characteristic due to the difference in the responsiveness of the actuator 2 will be described with reference to FIGS. 4A-4C.

FIGS. 4A-4C is a view showing the change in the transfer characteristic due to the difference in responsiveness of an actuator 2 when a function T_{filt1}, T_{filt2} are used as the correction function. In FIGS. 4A-4C, for comparison, the transfer characteristic when the correction function is not used, that is, the transfer characteristics of Equation (6), are indicated by broken lines.

FIG. 4A is a view showing transfer characteristics when the responsiveness of the actuator 2 is low, and FIG. 4B is a view showing transfer characteristics when the responsiveness of the actuator 2 is high. The coefficient Mₙ of the second-order term of the Laplace operator of the numerator of the respective function T_{filt1}, T_{filt2} used in FIG. 4A and FIG. 4B is a predetermined value M₁.

FIG. 4C is a view showing transfer characteristics when the responsiveness of the actuator 2 is low as in FIG. 4A, but is a view when the coefficient Mₙ of the second-order term of the Laplace operator of the respective function T_{filt1}, T_{filt2} is changed to a predetermined value M₂ which is twice the value of M₁.

As shown in FIGS. 4A and 4B, when the responsiveness of the actuator 2 is low, it can be seen that the damping performance is deteriorated as compared with the case where the responsiveness of the actuator 2 is high.

On the other hand, as shown in FIG. 4C, it can be seen that the damping performance can be improved even when the responsiveness of the actuator 2 is low by increasing the coefficient Mₙ of the second-order term of the Laplace operator of the numerator of the respective functional T_{filt1}, T_{filt2}.

Therefore, the damping performance can be improved by setting the value of the coefficient Mₙ of the second-order term of the Laplace operator of the numerator of the respective functional T_{filt1}, T_{filt2} to an appropriate value based on the responsiveness of the actuator 2.

In designing the respective function T_{filt1}, T_{filt2}, the unsprung mass M₁ and the spring constant K₁ of the tire are designed according to the tire to be actually used in the vehicles. However, an error occurs between a design value and an actual value. Further, since the tire and the like may be replaced, the error is likely to occur between the design value and the actual value.

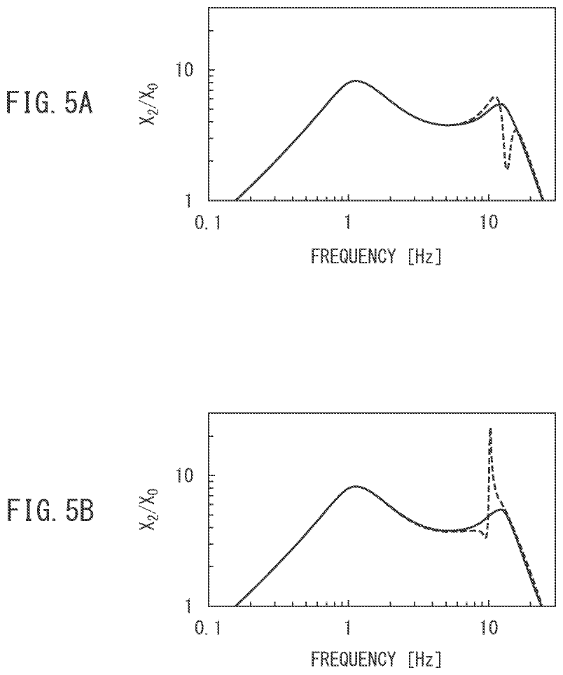

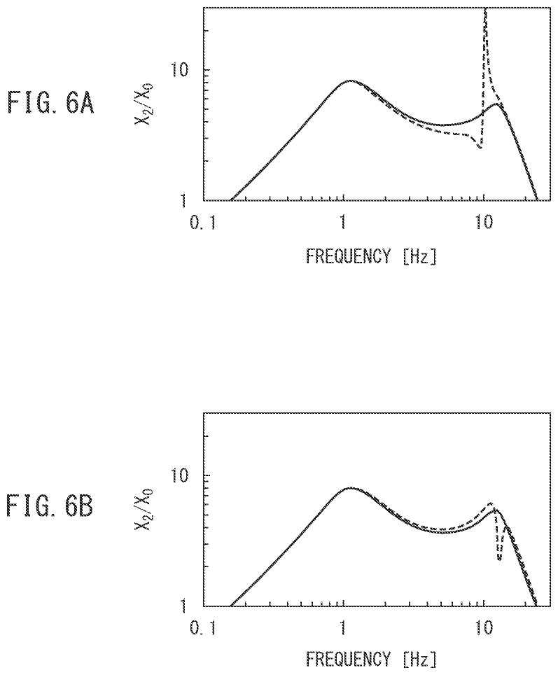

FIGS. 5A and 5B and FIGS. 6A and 6B show transfer characteristics obtained when the design value is made smaller than the actual value and when the design value is made larger in anticipation of the occurrence of such an error.

Specifically, FIG. 5A is a view showing a transfer characteristic (solid line) in a case where the unsprung mass M₁ is made to be equal to the actual value, and a transfer characteristic (broken line) in a case where the unsprung mass M₁ is made smaller than the actual value. FIG. 5B is a view showing a transfer characteristic (solid line) in a case where the unsprung mass M₁ is set to be equal to the actual value and a transfer characteristic (broken line) in a case where the unsprung mass M₁ is set to be larger than the actual value. FIG. 6A is a view showing a transfer characteristic (solid line) when the spring constant K₁ of the tire is made equal to the actual value, and a transfer characteristic (broken line) when the spring constant K₁ of the tire is made smaller than the actual value. FIG. 6B is a view showing a transfer characteristic (solid line) when the spring constant K₁ of the tire is made to be equal to the actual value, and a transfer characteristic (broken line) when the spring constant K₁ of the tire is made larger than the actual value.

As shown in FIG. 5A, when the unsprung mass M₁ is made smaller than the actual value, the damping performance of the high frequency band including the fixed point frequency band is improved as compared with the case where the unsprung mass M₁ is made equal to the actual value. On the other hand, as shown in FIG. 5B, when the unsprung mass M₁ is larger than the actual value, the damping performance of the high frequency band including the fixed point frequency band is deteriorated as compared with the case where the unsprung mass M₁ is set to the actual value.

In contrast, as shown in FIG. 6A, when the spring constant K₁ of the tire is made smaller than the actual value, the damping performance of the high frequency band including the fixed point frequency band is deteriorated as compared with the case where the spring constant K₁ of the tire is made equal to the actual value. On the other hand, as shown in FIG. 6B, when the spring constant K₁ of the tire is set to be larger than the actual value, the damping performance of the high frequency band including the fixed point frequency band is improved as compared with the case where the spring constant K₁ of the tire is set to be equal to the actual value.

Therefore, with respect to the unsprung mass M₁ in designing the respective function T_{filt1}, T_{filt2}, by keeping the damping performance within an allowable range by using a value larger than the actual value, even if an error occurs between the design value and the actual value, the actual value is basically smaller than the design value, and thus the damping performance can be kept within an allowable range. On the other hand, with respect to the spring rate K₁ of the tire in designing the respective function T_{filt1}, T_{filt2}, by keeping the damping performance within an allowable range by using a value smaller than the actual value, even if an error occurs between the design value and the actual value, the actual value basically becomes larger than the design value, and thus the damping performance can be kept within an allowable range.

The vehicle vibration damping system 100 according to the present embodiment described above is provided with the suspension 1 configured to connect the unsprung structure 5 including the tire and the sprung structure 6 including the vehicle body, the actuator 2 configured to apply a vertical control force between the unsprung structure 5 and the sprung structure 6, and the control device 4 configured to calculate a damping force to be applied to the sprung structure 6 on the basis of the theory of skyhook control, and control the actuator on the basis of the damping force. The control device 4 is configured to calculate the damping force based on a correction control parameter T_{sky} obtained by multiplying a control parameter T_{sky0} of a denominator of a transfer function G(s) of the sprung structure 6 with respect to a road surface displacement of the two-degree of freedom vibration model (vibration model) having the virtual skyhook damper 7 by the correction function T_{filt} (function) for canceling a coefficient (M₁s²+K₁) of a control parameter term. The control parameter T_{sky0} is a product of the damping coefficient C₃ of the skyhook damper 7 and the Laplace operator “s”. The correction function T_{filt} is a function having the coefficient (M₁s²+K₁) of the control parameter term of the transfer function G(s) as a denominator, that is, the function T_{filt1} including at least a second-order term of a Laplace operator in the numerator, or the function T_{filt2} further including a first-order term of a Laplace operator in the numerator.

Due to this, when the function T_{filt1} is used as the correction function, the damping performance of the high frequency band including the fixed point frequency band can be improved. When the function T_{filt2} is used as the correction function, the damping performance of the medium frequency band in addition to the high frequency band including the fixed point frequency band can also be improved.

Above, embodiments of the present disclosure were explained, but the embodiments only show some of the examples of application of the present disclosure and are not intended to limit the technical scope of the present disclosure to the specific constitutions of the embodiments.

For example, in the above described embodiment, in the two degree of freedom vibration model of FIG. 2, the spring constant K₁ of the tire is considered, but the damping coefficient C₁ of the tire is not considered. On the other hand, when the damping coefficient C₁ of the tire is considered, the coefficient of the control parameter term of the transfer function becomes M₁s²+C₁·s+K₁, and thus the respective function T_{filt1}, T_{filt2} are expressed by the following equations (13) and (14).

$$\begin{matrix}[ Mathematical 8 ] & \\ {T}_{filt 1} = \frac{{K}_{1} + {M}_{n} {s}^{2}}{{M}_{1} {s}^{2} + {C}_{1} s + {K}_{1}} & ( 13 )\end{matrix}$$

$${T}_{filt 2} = \frac{{K}_{1} + {C}_{n} s + {M}_{n} {s}^{2}}{{M}_{1} {s}^{2} + {C}_{1} s + {K}_{1}} . \qquad ( 14 )$$

1. A vehicle vibration damping system comprising:
a suspension configured to connect an unsprung structure including a tire and a sprung structure including a vehicle body;
an actuator configured to apply a vertical control force between the unsprung structure and the sprung structure; and
a control device configured to calculate a damping force to be applied to the sprung structure on a basis of a theory of skyhook control, and control the actuator on a basis of the damping force, wherein
the control device is configured to calculate the damping force based on a correction control parameter obtained by multiplying a control parameter of a denominator of a transfer function of the sprung structure with respect to a road surface displacement of a vibration model having a virtual skyhook damper by a function for canceling a coefficient of a control parameter term, and
the control parameter is a product of a damping coefficient of the virtual skyhook damper and a Laplace operator, and
the function is a function having a coefficient of the control parameter term of the transfer function as a denominator, and includes at least a second-order term of the Laplace operator in a numerator.

2. The vehicle vibration damping system according to claim 1, wherein
the function is a function further including a first-order term of the Laplace operator in the numerator.

3. The vehicle vibration damping system according to claim 1, wherein,
when a responsiveness of the actuator is low, a value of the coefficient of the second-order term of the Laplace operator of the function is set based on the responsiveness of the actuator so that the value of the coefficient of the second-order term of the Laplace operator of the molecular of the function becomes larger than in a case where the responsiveness of the actuator is high.

4. The vehicle vibration damping system according to claim 1, wherein,
in the vibration model, when mass of the unsprung structure is M₁, a spring constant of the tire is K₁, a damping coefficient of the tire is C₁, the Laplacian operator is s, and a coefficient Mₙ is a predetermined constant, the function is expressed by Equation (1) or Equation (2) below;
$$\begin{matrix}[ Mathematical 1 ] & \\ \frac{{K}_{1} + {M}_{n} {s}^{2}}{{M}_{1} {s}^{2} + {K}_{1}} & ( 1 )\end{matrix}$$
$$\frac{{K}_{1} + {M}_{n} {s}^{2}}{{M}_{1} {s}^{2} + {C}_{1} s + {K}_{1}} . \qquad ( 2 )$$

5. The vehicle vibration damping system according to claim 1, wherein,
in the vibration model, when mass of the unsprung structure is M₁, a spring constant of the tire is K₁, a damping coefficient of the tire is C₁, the Laplacian operator is s, and a coefficient Mₙ and a coefficient Cₙ are predetermined constants, the function is expressed by Equation (3) or Equation (4) below;
$$\begin{matrix}[ Mathematical 2 ] & \\ \frac{{K}_{1} + {C}_{n} s + {M}_{n} {s}^{2}}{{M}_{1} {s}^{2} + {K}_{1}} & ( 3 )\end{matrix}$$
$$\frac{{K}_{1} + {C}_{n} s + {M}_{n} {s}^{2}}{{M}_{1} {s}^{2} + {C}_{1} s + {K}_{1}} . \qquad ( 4 )$$
